(19) United States
(12) Patent Application Publication
(10) Pub. No.: US 2019/0249461 A1
(43) Pub. Date: Aug. 15, 2019

(54) CABINET LATCH

(71) Applicant: Paul Herskovitz, Northbrook, IL (US)

(72) Inventor: Paul Herskovitz, Northbrook, IL (US)

(21) Appl. No.: 16/258,559

(22) Filed: Jan. 26, 2019

Related U.S. Application Data
(60) Provisional application No. 62/629,222, filed on Feb. 12, 2018.

(51) Int. Cl. E05B 65/44; E05B 17/00; E05B 65/00; E05B 65/46; E05B 65/02

(52) U.S. Cl. CPC E05B 65/44; E05B 17/0058; E05B 53/00; E05B 65/46; E05B 65/02; E05B 65/0014

(57) ABSTRACT

A latch for a cabinet door or drawer has a pawl movable to a plurality of positions such according to the cabinet's configuration and finger size wherein an optimal finger gap may be created between the cabinet and the door or drawer for accessing and releasing the latch to open the door or drawer.

### RELATED APPLICATION

This application claims priority to U.S. Provisional Application No. 62/629,222 filed 12 Feb. 2018 whose disclosure is incorporated herein by reference in its entirety.

### FIELD OF THE INVENTION

The invention is related to safety systems and mechanisms for preventing access to cabinets and such, especially by children. More specifically, the invention is related to adjustable cabinet door safety latches.

### BACKGROUND

Devices intended to prevent access by children into kitchen and bathroom cabinets are common and well known. A common drawback to such devices is their inability to be instantly and simply adapted to different cabinets having different structures and dimensions. Another common drawback to such devices is their inability to be instantly and simply adapted for use by persons having wider and narrower fingers.

There exists the need for a latching mechanism with is inexpensive, instantly affixable to a cabinet or such, able to prevent access by those of less manual dexterity, such as children, and instantly and simply adjustable to fit and function with cabinets and such of a variety of structures and dimensions, and instantly and simply adjustable for use by persons having wider and narrower fingers, and these are all included in the objects of the present invention.

Further needs and objects will become apparent upon reading the disclosure contained herein.

### SUMMARY OF THE INVENTION

The invention may be embodied in or practiced using a latch having a pawl with a reach that is adjustable to be varied according to the arrangement of the cabinet with which it is to be used.

The invention may be embodied in or practiced using, in combination, a cabinet and a latching system for selectably impeding the opening of a door or drawer of the cabinet wherein the cabinet has a face, an inner wall, and the door or drawer, the door or drawer has an inside surface, and the cabinet has a depth from the inside surface to the inner wall when the door or drawer is in a closed position.

The latching system may have a base, an arm and a pawl. The base may have means for rigid affixation to the inside surface. The arm may engage the base at a proximal arm end and may be projectable at a distal arm end into the cabinet inwardly beyond the inner wall. The arm may be movable relative to the base from a lowest position to a highest position, and may be biased towards the highest position. The pawl may have a ramp and a holding edge. The pawl may be selectably affixable to the arm at a plurality of positions such that the holding edge is adjustable to a selected position whereby the holding edge is separated from the inside surface by a distance equal to the depth and a gap width. The pawl may be movable with the arm relative to the base, wherein with the base affixed to the inside surface and the pawl affixed to the arm so that the holding edge is at the selected position, the door may be moved from an open to the closed position, where-during the ramp is adapted to engage the face and force the arm towards the lowest position and thereby force the holding edge below the inner wall such that the door may be fully closed, and when the door approaches the closed position, the ramp passes the inner wall and the arm moves towards the highest position, and wherein the door is then movable from the closed position to a partially open position where-at the inside surface is separated from the face by the gap width and the holding edge engages the inner wall and prevents the door from opening further.

The arm may further include a finger pad configured to be disposed between the inner surface and the face when the door is in the partially open position.

The arm may include a plurality of notches and the pawl may have one or more pins adapted to mate with the notches to enable selectable affixation of the pawl to the arm at the plurality of positions.

The one or more pins may be two pins including a snap pin and a pivot pin, and the plurality of notches may include a second plurality snap notches and a third plurality of pivot notches, wherein the pivot notches are each configured to selectively entrap the pivot pin in pivoting engagement and the snap notches are each configured to selectively entrap the snap pin.

The pivot pin may have a flat top and each pivot notch may have an opening having a boss protruding partly there-across so that the pivot pin, when rotated ninety or so angular degrees upwardly, can pass down into the pivot notch, but when pivoted back down will cause the flat top to engage an underside of the boss and retain the pivot pin inside the pivot notch.

The snap notch may be cylindrical and may have a diameter and each snap notch may have a top opening that is narrowed to slightly less that the diameter so that the snap pin must be forced downwardly therethrough to be received into the snap notch, and must be forced upwardly therethrough to be removed from the snap notch.

The pivot notches and snap notches may be spaced apart so that each pivot notch has a paired snap notch arranged to receive the snap pin when the pivot pin is rotated downwardly within the pivot notch.

The invention may also be embodied in or practiced using, in combination, a cabinet and a latching system for selectably impeding the opening of a door or drawer of the cabinet wherein the cabinet has a face and the door or drawer, and the door or drawer has an inside surface.

The latching system may include a base, an arm, a pawl, and a retainer. The retainer may have a retaining wall and may be affixable within an interior of the cabinet whereby the retaining wall is disposed parallel to the inside surface and at a depth from the inside surface to the retaining wall when the door or drawer is in a closed position. The base may have means for rigid affixation to the inside surface. The arm may engage the base at a proximal arm end and may be projectable at a distal arm end into the cabinet inwardly beyond the retaining wall. The arm may be movable relative to the base from a lowest position to a highest position, and may be biased towards the highest position. The pawl may have a ramp and a holding edge. The pawl may be selectably affixable to the arm at a plurality of positions such that the holding edge is adjustable to a selected position whereby the holding edge is separated from the inside surface by a distance equal to the depth and a gap width. The pawl may be movable with the arm relative to the base wherein with the base affixed to the inside surface and the pawl affixed to the arm so that the holding edge is at the selected position, the door may be moved from an open to the closed position, where-during the ramp is adapted to engage the face and force the arm towards the lowest position and thereby force the holding edge below the retaining wall such that the door may be fully closed, and when the door approaches the closed position, the ramp passes the retaining wall and the arm moves towards the highest position; and wherein the door is then movable from the closed position to a partially open position where-at the inside surface is separated from the face by the gap width and the holding edge engages the retaining wall and prevents the door from opening further. The arm may further include a finger pad configured to be disposed between the inner surface and the face when the door is in the partially open position.

The arm may include a plurality of notches and the pawl may have one or more pins adapted to mate with the notches to enable selectable affixation of the pawl to the arm at the plurality of positions.

The one or more pins may be two pins comprising a snap pin and a pivot pin, and the plurality of notches may include a second plurality snap notches and a third plurality of pivot notches, and the pivot notches may be each configured to selectively entrap the pivot pin in pivoting engagement and the snap notches are each configured to selectively entrap the snap pin.

The pivot pin may have a flat top and each pivot notch may have an opening having a boss protruding partly there-across so that the pivot pin, when rotated ninety or so angular degrees upwardly, can pass down into the pivot notch, but when pivoted back down will cause the flat top to engage an underside of the boss and retain the pivot pin inside the pivot notch.

The snap notch may be cylindrical and may have a diameter and each snap notch may have a top opening that is narrowed to slightly less that the diameter so that the snap pin must be forced downwardly therethrough to be received into the snap notch, and must be forced upwardly therethrough to be removed from the snap notch.

The pivot notches and snap notches may be spaced apart so that each pivot notch has a paired snap notch arranged to receive the snap pin when the pivot pin is rotated downwardly within the pivot notch.

The invention may further be embodied by or practiced using one of the above latching systems despite a combination.

Further features and aspects of the invention are disclosed with more specificity in the Detailed Description and Drawings provided herein and showing exemplary embodiments of the invention.

### BRIEF DESCRIPTION OF THE DRAWINGS

An exemplary embodiment of a cabinet latching system is shown in the accompanying Drawings, of which;

FIG. 1 is a perspective view of a cabinet door and the latching system with its arm and pawl in its latching position;

FIG. 2 is a is a perspective view of the cabinet door and the latching system of FIG. 1 with its arm and pawl being moved to its unlatching position;

FIG. 3 is an exploded view of the latching system of FIG. 1;

FIG. 4 is a is a side view of the latching system of FIG. 1 with the pawl being attached to the arm;

FIG. 5 is a side view of the latching system of FIG. 1 with the pawl attached to the arm;

FIG. 6 is a side view of a cabinet and the latching system of FIG. 1 with the arm and pawl in the latching position and the cabinet door fully closed;

FIG. 7 is a is a side view of the cabinet and the latching system of FIG. 6 with the arm and pawl in the latching position and the cabinet door opened by the gap width;

FIG. 8 is a side view of the cabinet and the latching system of FIG. 6 with the arm and pawl moved to the unlatching position and the cabinet door being opened;

FIG. 9 is a perspective view of the pawl being removed from the arm for re-positioning; and

FIG. 10 is a side view of the latching system of FIG. 1 used with a retainer.

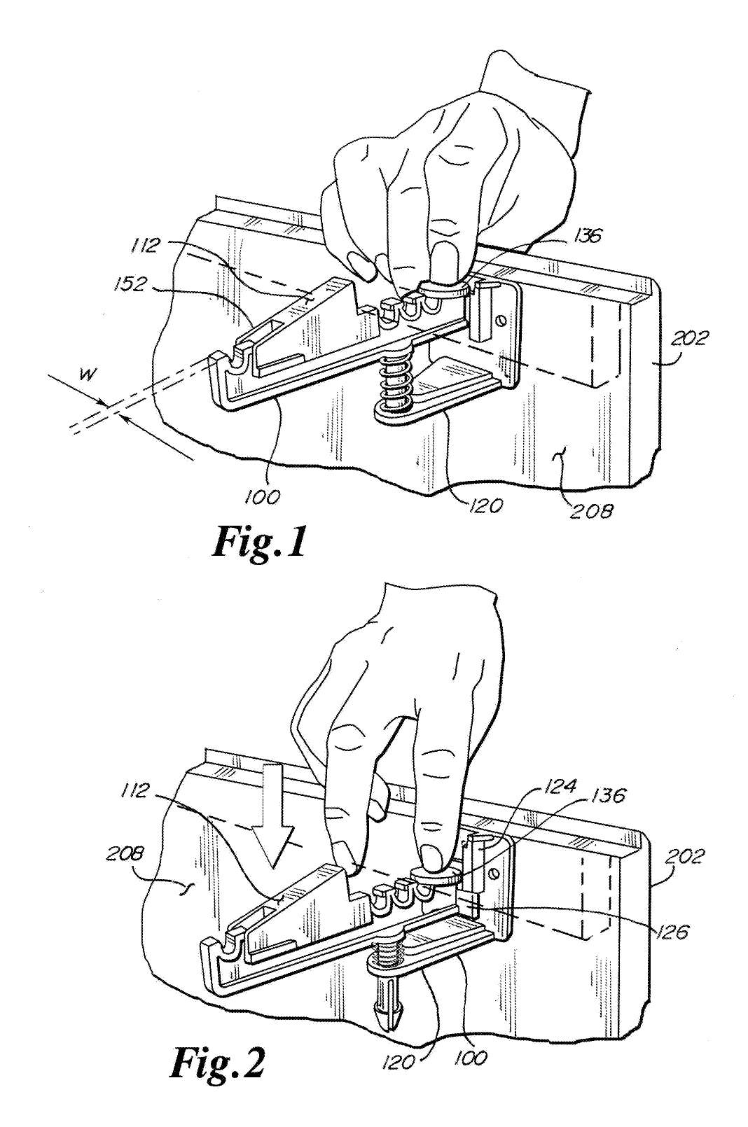

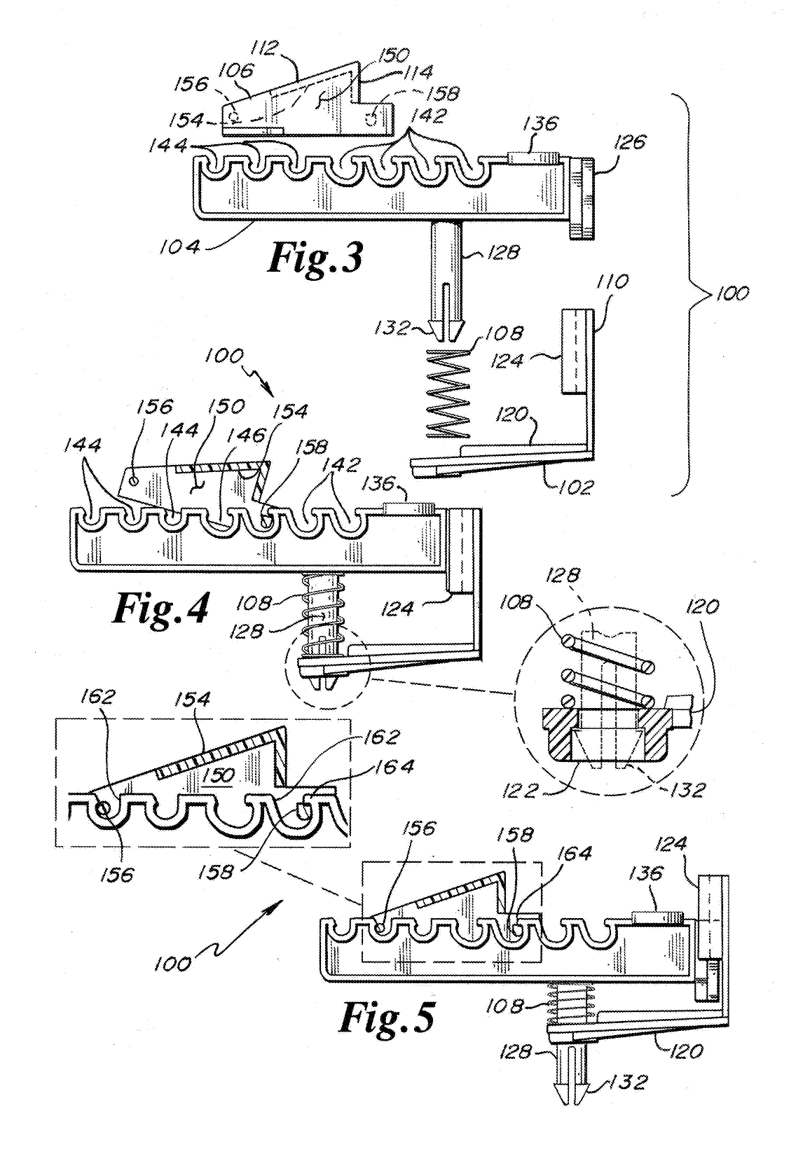

### DETAILED DESCRIPTION OF EXEMPLARY EMBODIMENTS

The invention may be embodied in or practiced using the exemplary latching system 100 of the included drawings and the following description for selectably impeding the opening of the door 202 relative to cabinet 200;

While the latching system is primarily intended to be used such things as the doors or drawers of kitchen cabinets as shown, it may alternatively be used with an infinite variety of other articles such as, but not limited to, furniture, entry doors, lockers, jewelry boxes and chests. In fact, the invention may include the latching system in combination with such articles. Cabinet 200 has a face 204, an inner wall 206, and door 202 with an inside surface 208.

While reference will be made in this disclosure and the following claims to directional terms like vertical and horizontal, it should be understood that such terms are applicable to use in cabinets like cabinet 200, and such, which have doors that swing about a vertical hinge axis, and which therefore have a vertical face and inside surface. But it is anticipated that the latching system could also be used in combination with other articles, like for instance a jewelry box having a horizontally swinging door, and as such, these directional terms are intended to then be re-interpreted accordingly.

Latching system 100 has a base 102, an arm 104, a pawl 106, and a compression spring 108. The base, arm, and pawl are preferable made of molded plastic and the spring is preferably made of steel. The base has a vertically planar mounting surface 110 which, when mounted to the door, is coplanar with the door's inside surface. The pawl has an inclined ramp 112 and a vertical holding edge 114.

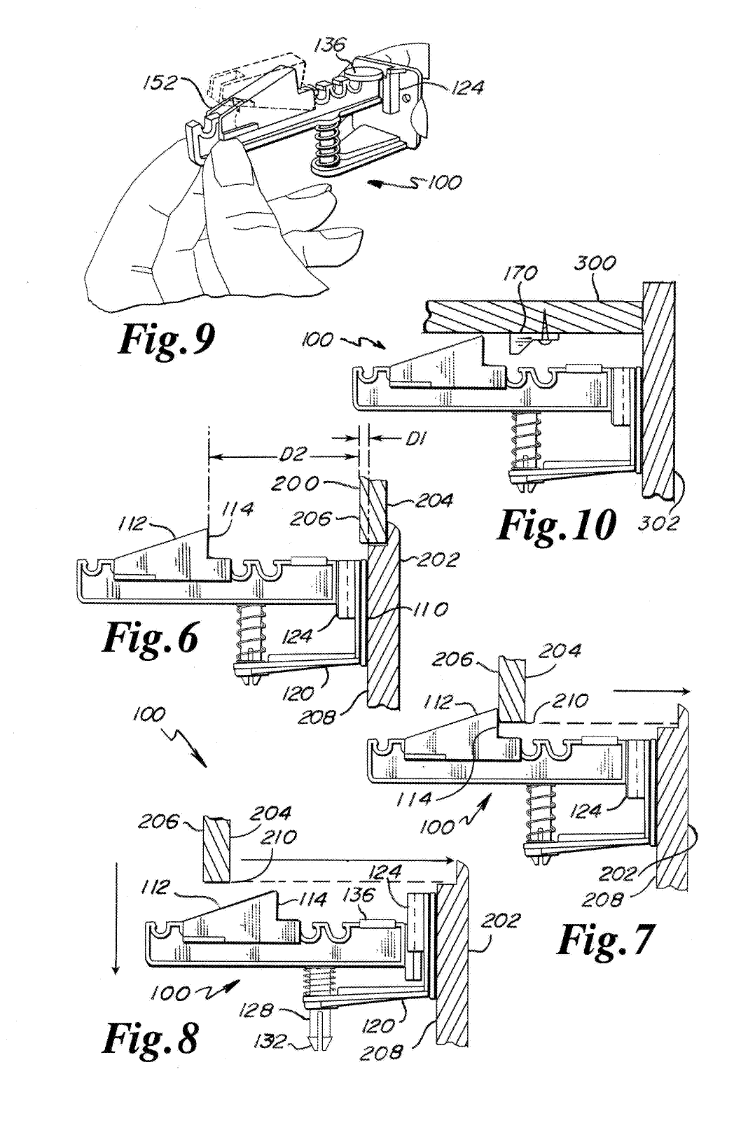

The cabinet has a depth D1 from the door's inside surface 208 to the inner wall 206 when the door is in the closed position of FIG. 6. The latching system has a depth D2 from the mounting surface 110 to the holding edge 114, which may be varied according to user preference and cabinet dimensions.

The base may be provided with an adhesive on mounting surface 110, preferably a layer of 3M PE adhesive foam with a protective cover layer that is removed prior to installation, or may alternatively be provided mounting holes and fasteners such as screws, with which it is affixed to the inside surface 208.

The base includes horizontal shelf 120 projecting inwardly (into the cabinet) which includes a vertically directed through hole 122. The base further includes a vertical channel 124.

The arm includes vertical T-flange 126 which is adapted to be vertically slindingly received by the channel, and a downwardly projecting post 128 which has a diameter slightly smaller than the diameter of the through hole and a split-mushroom head 132 that is adapted to snap through the through hole after compression spring 108 is disposed around the post. This captures the spring between the arm and the base, allowing the arm to move vertically relative to the base within the limits of the arrangement; namely, the highest position that the arm can travel relative to the base is limited by the interference of the split-mushroom head and the underside of the through hole. And the lowest position that the arm can travel is limited by the height of the spring when compressed. This distance from lowest to the highest position is greater than the height of the holding edge. The spring biases the arm towards the highest position. The arm and base are rigidly connected in the horizontal direction.

The arm also includes a finger pad 136 which facilitates temporarily pushing the arm down relative to the base against the spring's bias. This pad is located atop the arm's proximal end.

The arm thereby projects inwardly towards its distal end which extends into the cabinet beyond the inner wall 206.

A key feature of the latching mechanism is that the pawl is selectably affixable to the arm at a plurality of positions away from the cabinet door so that the holding edge is adjustable to a selected position. This allows the holding edge to be separated from the inside of the door or drawer by a distance equal to the depth and a user-preferred gap width. This is accomplished by a series of notches along the top of the arm; pivot notches 142, snap notches 144, and hybrid notch 146, each having a top opening 162.

The pawl is made of two parallel planar vertical side plates 150 separated by a space 152 that is slightly wider than the width W of the arm. The plates are rigidly connected by a spanning wall 154 that forms a portion of both the ramp 112 and the holding edge 114, and by two spanning pins, snap pin 156 and pivot pin 158. Snap pin 156 is cylindrical and pivot pin 158 is U-shaped. Cylindrical snap pin 156 has a diameter sized to temporarily snap into any of the snap notches 144 or the hybrid notch 146, and U-shaped pivot pin 158 is shaped and sized to fit into any of snap notches 144 or the hybrid notch 146. The top openings of the snap notches and hybrid notch are narrowed to slightly less that the diameter of the snap pin so that the snap pin must be forced downwardly therethrough to be received into the selected notch, and must be forced upwardly therethrough to be removed from the notch. The top openings of the pivot notches and hybrid notch have a boss 164 protruding partly there-across so that the U-shaped pivot pin, when rotated ninety or so angular degrees upwardly, can pass down into the selected notch, but when then pivoted back down will cause the flat top of the pin to engage the underside of the boss and retain the pin inside its selected notch as the snap pin is snapped into its selected notch. In this way, the pawl has a plurality of discrete positions away from the door that the user can choose, and once snapped into pace becomes a rigid part of the arm that may move up and down therewith.

The user chooses which notches to engage the pawl with according to two factors. The first of those being the dimensional arrangement of the cabinet . . . specifically depth D1. The second being the desired gap width, D2 minus D1. The gap width is preferably slightly wider that the user's finger, to allow the user to reach his/her finger through the gap to access finger pad 136 and depress the arm and pawl.

With the latch system so mounted and adjusted, and the cabinet door opened, the user needs only push the door closed form outside and the ramp of the pawl will engage the cabinet at lower corner 210 of face 204 to force the pawl downwardly against the spring bias and allow holding edge to pass under corner 210 and allow the door to fully close.

As holding edge 114 passes inner wall 206, the spring forces the pawl back up so that the holding edge is again higher than corner 210. Now, if a child tried to pull the door open, the holding edge will hit the inner wall as soon as the door is opened to the gap width and the child will be unable to access the interior of the cabinet. But if the user wished to access the interior, he/she need to merely reach his/her finger through the gap and depress the arm/pawl to cause the holding edge to move below corner 210 so that the door may be fully opened.

An additional feature of the latching system is a user-attachable retainer 170 which may be affixed within reach of the holding edge to any horizontal inner underside surface 302 of a cabinet 300 that lacks such an inner wall. This is shown in FIG. 10. The user must simply determine the proper positioning of the retainer, as shown, and then affix the retainer to the underside surface using an adhesive layer or fasteners, and then the retainer functions as corner 210 and inner wall 206 of the previous example.

While the invention has been shown and described with reference to a specific exemplary embodiment, it should be understood by those skilled in the art that various changes in form and detail may be made without departing from the spirit and scope of the invention, and that the invention should therefore only be limited according to the following claims, including all equivalent interpretation to which they are entitled.

I claim:

1. In combination, a cabinet and a latching system for selectably impeding the opening of a door or drawer of the cabinet;
the cabinet comprising a face, an inner wall, and the door or drawer;
the door or drawer having an inside surface;
the latching system comprising a base, an arm and a pawl;
the cabinet having a depth from the inside surface to the inner wall when the door or drawer is in a closed position;
the base having means for rigid affixation to the inside surface;
the arm engaging the base at a proximal arm end and projectable at a distal arm end into the cabinet inwardly beyond the inner wall;
the arm being movable relative to the base from a lowest position to a highest position, and being biased towards the highest position;
the pawl having a ramp and a holding edge;
the pawl being selectably affixable to the arm at a plurality of positions such that the holding edge is adjustable to a selected position whereby the holding edge is separated from the inside surface by a distance equal to the depth and a gap width;
the pawl being movable with the arm relative to the base;
wherein with the base affixed to the inside surface and the pawl affixed to the arm so that the holding edge is at the selected position, the door may be moved from an open to the closed position, where-during the ramp is adapted to engage the face and force the arm towards the lowest position and thereby force the holding edge below the inner wall such that the door may be fully closed, and when the door approaches the closed position, the ramp passes the inner wall and the arm moves towards the highest position; and
wherein the door is then movable from the closed position to a partially open position where-at the inside surface is separated from the face by the gap width and the holding edge engages the inner wall and prevents the door from opening further.

2. The combination of claim 1 wherein the arm further comprises a finger pad configured to be disposed between the inner surface and the face when the door is in the partially open position.

3. The combination of claim 1 wherein the arm comprises a plurality of notches and the pawl comprises one or more pins adapted to mate with the notches to enable selectable affixation of the pawl to the arm at the plurality of positions.

4. The combination of claim 3 wherein the one or more pins is two pins comprising a snap pin and a pivot pin, and the plurality of notches comprise a second plurality snap notches and a third plurality of pivot notches, and wherein the pivot notches are each configured to selectively entrap the pivot pin in pivoting engagement and the snap notches are each configured to selectively entrap the snap pin.

5. The combination of claim 4 wherein the pivot pin comprises a flat top and each pivot notch comprises an opening having a boss protruding partly there-across so that the pivot pin, when rotated ninety or so angular degrees upwardly, can pass down into the pivot notch, but when pivoted back down will cause the flat top to engage an underside of the boss and retain the pivot pin inside the pivot notch.

6. The combination of claim 5 wherein the snap notch is cylindrical and has a diameter and each snap notch comprises a top opening that is narrowed to slightly less that the diameter so that the snap pin must be forced downwardly therethrough to be received into the snap notch, and must be forced upwardly therethrough to be removed from the snap notch.

7. The combination of claim 6 wherein the pivot notches and snap notches are spaced apart so that each pivot notch has a paired snap notch arranged to receive the snap pin when the pivot pin is rotated downwardly within the pivot notch.

8. In combination, a cabinet and a latching system for selectably impeding the opening of a door or drawer of the cabinet;
the cabinet comprising a face and the door or drawer;
the door or drawer having an inside surface;
the latching system comprising a base, an arm, a pawl, and a retainer;
the retainer having a retaining wall and being affixable within an interior of the cabinet whereby the retaining wall is disposed parallel to the inside surface and at a depth from the inside surface to the retaining wall when the door or drawer is in a closed position;
the base having means for rigid affixation to the inside surface;
the arm engaging the base at a proximal arm end and projectable at a distal arm end into the cabinet inwardly beyond the retaining wall;
the arm being movable relative to the base from a lowest position to a highest position, and being biased towards the highest position;
the pawl having a ramp and a holding edge;
the pawl being selectably affixable to the arm at a plurality of positions such that the holding edge is adjustable to a selected position whereby the holding edge is separated from the inside surface by a distance equal to the depth and a gap width;
the pawl being movable with the arm relative to the base;
wherein with the base affixed to the inside surface and the pawl affixed to the arm so that the holding edge is at the selected position, the door may be moved from an open to the closed position, where-during the ramp is adapted to engage the face and force the arm towards the lowest position and thereby force the holding edge below the retaining wall such that the door may be fully closed, and when the door approaches the closed position, the ramp passes the retaining wall and the arm moves towards the highest position; and
wherein the door is then movable from the closed position to a partially open position where-at the inside surface is separated from the face by the gap width and the holding edge engages the retaining wall and prevents the door from opening further.

9. The combination of claim 8 wherein the arm further comprises a finger pad configured to be disposed between the inner surface and the face when the door is in the partially open position.

10. The combination of claim 8 wherein the arm comprises a plurality of notches and the pawl comprises one or more pins adapted to mate with the notches to enable selectable affixation of the pawl to the arm at the plurality of positions.

11. The combination of claim 10 wherein the one or more pins is two pins comprising a snap pin and a pivot pin, and the plurality of notches comprise a second plurality snap notches and a third plurality of pivot notches, and wherein the pivot notches are each configured to selectively entrap the pivot pin in pivoting engagement and the snap notches are each configured to selectively entrap the snap pin.

12. The combination of claim 11 wherein the pivot pin comprises a flat top and each pivot notch comprises an opening having a boss protruding partly there-across so that the pivot pin, when rotated ninety or so angular degrees upwardly, can pass down into the pivot notch, but when pivoted back down will cause the flat top to engage an underside of the boss and retain the pivot pin inside the pivot notch.

13. The combination of claim 12 wherein the snap notch is cylindrical and has a diameter and each snap notch comprises a top opening that is narrowed to slightly less that the diameter so that the snap pin must be forced downwardly therethrough to be received into the snap notch, and must be forced upwardly therethrough to be removed from the snap notch.

14. The combination of claim 13 wherein the pivot notches and snap notches are spaced apart so that each pivot notch has a paired snap notch arranged to receive the snap pin when the pivot pin is rotated downwardly within the pivot notch.

15. A latching system for selectably impeding the opening of a door or drawer of a cabinet of the type having a face, an inner wall, the door or drawer with an inside surface, and a depth from the inside surface to the inner wall when the door or drawer is in a closed position;
the latching system comprising a base, an arm and a pawl;
the base having means for rigid affixation to the inside surface;
the arm engaging the base at a proximal arm end and projectable at a distal arm end into the cabinet inwardly beyond the inner wall;
the arm being movable relative to the base from a lowest position to a highest position, and being biased towards the highest position;
the pawl having a ramp and a holding edge;
the pawl being selectably affixable to the arm at a plurality of positions such that the holding edge is adjustable to a selected position whereby the holding edge is separated from the inside surface by a distance equal to the depth and a gap width;
the pawl being movable with the arm relative to the base;
wherein with the base affixed to the inside surface and the pawl affixed to the arm so that the holding edge is at the selected position, the door may be moved from an open to the closed position, where-during the ramp is adapted to engage the face and force the arm towards the lowest position and thereby force the holding edge below the inner wall such that the door may be fully closed, and when the door approaches the closed position, the ramp passes the inner wall and the arm moves towards the highest position; and
wherein the door is then movable from the closed position to a partially open position where-at the inside surface is separated from the face by the gap width and the holding edge engages the inner wall and prevents the door from opening further.

16. The latching system of claim 15 wherein the arm further comprises a finger pad configured to be disposed between the inner surface and the face when the door is in the partially open position.

17. The latching system of claim 15 wherein the arm comprises a plurality of notches and the pawl comprises one or more pins adapted to mate with the notches to enable selectable affixation of the pawl to the arm at the plurality of positions.

18. The latching system of claim 17 wherein the one or more pins is two pins comprising a snap pin and a pivot pin, and the plurality of notches comprise a second plurality snap notches and a third plurality of pivot notches, and wherein the pivot notches are each configured to selectively entrap the pivot pin in pivoting engagement and the snap notches are each configured to selectively entrap the snap pin.

19. The latching system of claim 18 wherein the pivot pin comprises a flat top and each pivot notch comprises an opening having a boss protruding partly there-across so that the pivot pin, when rotated ninety or so angular degrees upwardly, can pass down into the pivot notch, but when pivoted back down will cause the flat top to engage an underside of the boss and retain the pivot pin inside the pivot notch; and
wherein the snap notch is cylindrical and has a diameter and each snap notch comprises a top opening that is narrowed to slightly less that the diameter so that the snap pin must be forced downwardly therethrough to be received into the snap notch, and must be forced upwardly therethrough to be removed from the snap notch.

20. The latching system of claim 19 wherein the pivot notches and snap notches are spaced apart so that each pivot notch has a paired snap notch arranged to receive the snap pin when the pivot pin is rotated downwardly within the pivot notch.
